(19) United States
(12) Patent Application Publication
(10) Pub. No.: US 2002/0070556 A1
(43) Pub. Date: Jun. 13, 2002

(54) Energy conversion system

(76) Inventors: Bhanuprasad S. Patel, Raleigh, NC (US); Umang B. Patel, Raleigh, NC (US)

Correspondence Address: COATS & BENNETT, PLLC, P O BOX 5, RALEIGH, NC, 27602, US

(21) Appl. No.: 09/733,175

(22) Filed: Dec. 8, 2000

(51) Int. Cl. B60K 1/00

(52) U.S. Cl. 290/40 C; 180/65.1

(57) ABSTRACT

A power system or an energy system conversion including a bank of batteries operatively connected to a converter or voltage multiplier. The voltage multiplier adjusts the voltage from the bank of batteries and directs an output voltage to a DC motor. The DC motor in turn drives a gear box which in turn drives a workpiece. In the course of performing work, energy associated with the workpiece is captured and directed back through one or more electrical components where the recaptured energy is stored or otherwise used by the bank of batteries. In one embodiment of the present invention, the energy recaptured from the workpiece is directed to an alternator which is in turn connected to a voltage regulator. The energy provided by the alternator is used to drive the voltage regulator which in turn produces an output that is connected to the bank of batteries.

### SUMMARY OF THE INVENTION

The present invention relates to an energy conversion system that is utilized to convert the energy from a bank of batteries to a form of energy that can be utilized by a workpiece such as a gear assembly or a wheel and axle assembly. Basically, the energy conversion system includes one or more batteries connected in series. The voltage output of the batteries is directed to a converter or voltage multiplier. There the voltage is adjusted and the output of the converter or voltage multiplier is directed to a DC motor. It is appreciated that the converter or voltage multiplier can adjust the speed of the DC motor. The output of the DC motor is directed to a gear box which in turn is utilized to drive the workpiece or in the case of the embodiments illustrated herein a wheel and axle assembly. Some energy associated with the workpiece is captured and directed to an alternator and the alternator is driven by this energy. The alternator in turn includes an output that is directed to a voltage regulator and the output is operative to energize the voltage regulator. Finally, the voltage regulator is operatively connected or coupled to the one or more batteries and can be utilized to charge the individual batteries.

From time to time, an outside energy source may be supplied to the system. This can be in the form of a battery or freshly recharged bank of batteries or could be provided from simply an external source of energy.

### DESCRIPTION OF THE INVENTION

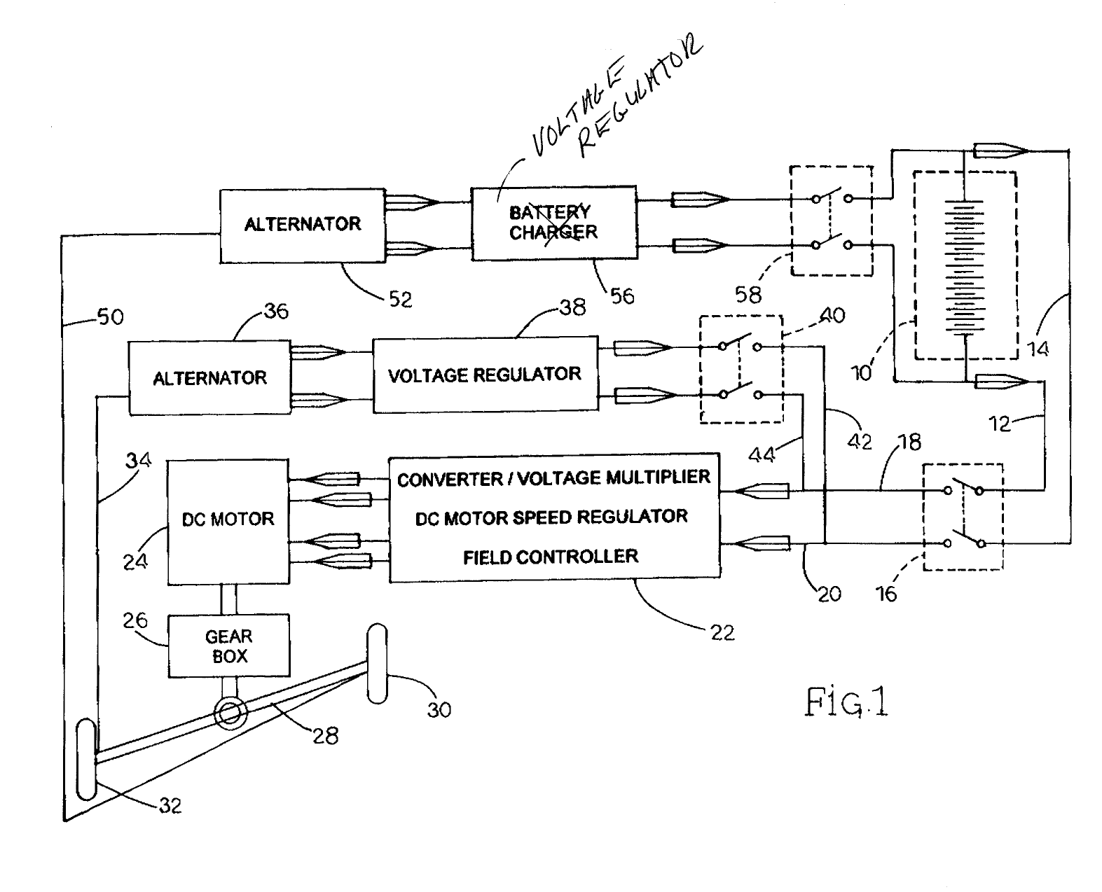

FIG. 1 is a schematic illustration of the energy conversion system of the present invention.

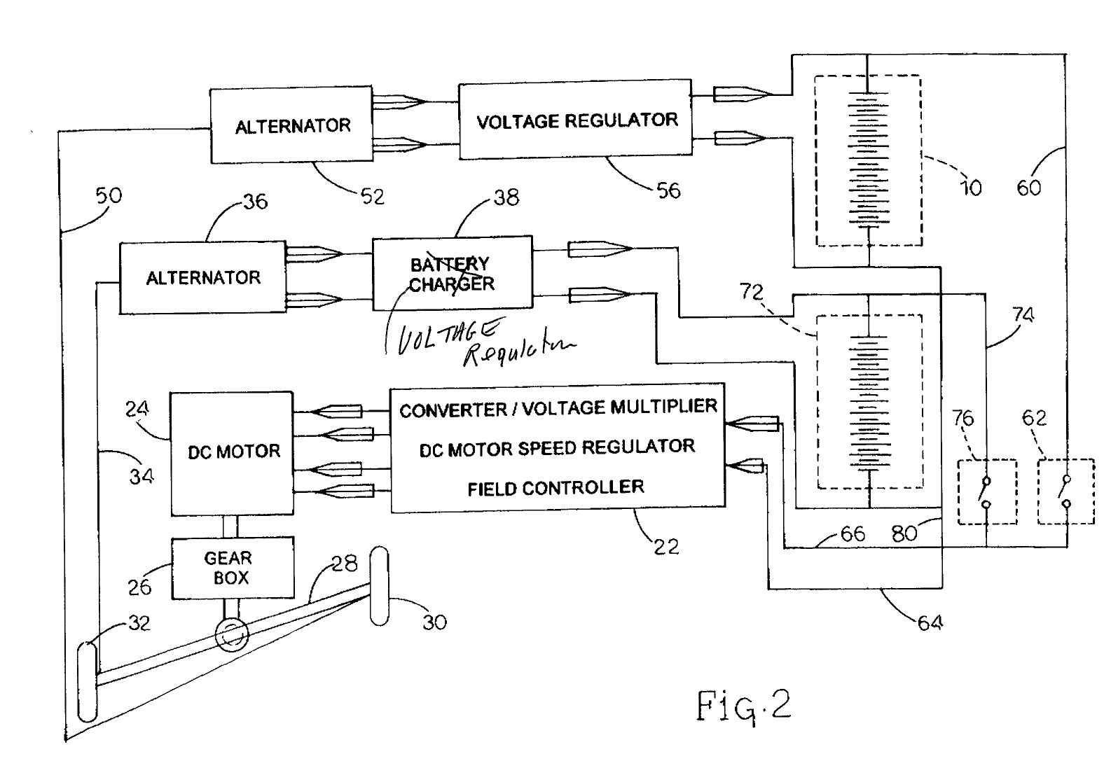

FIG. 2 is a schematic illustration of a second embodiment of the energy conversion system of the present invention.

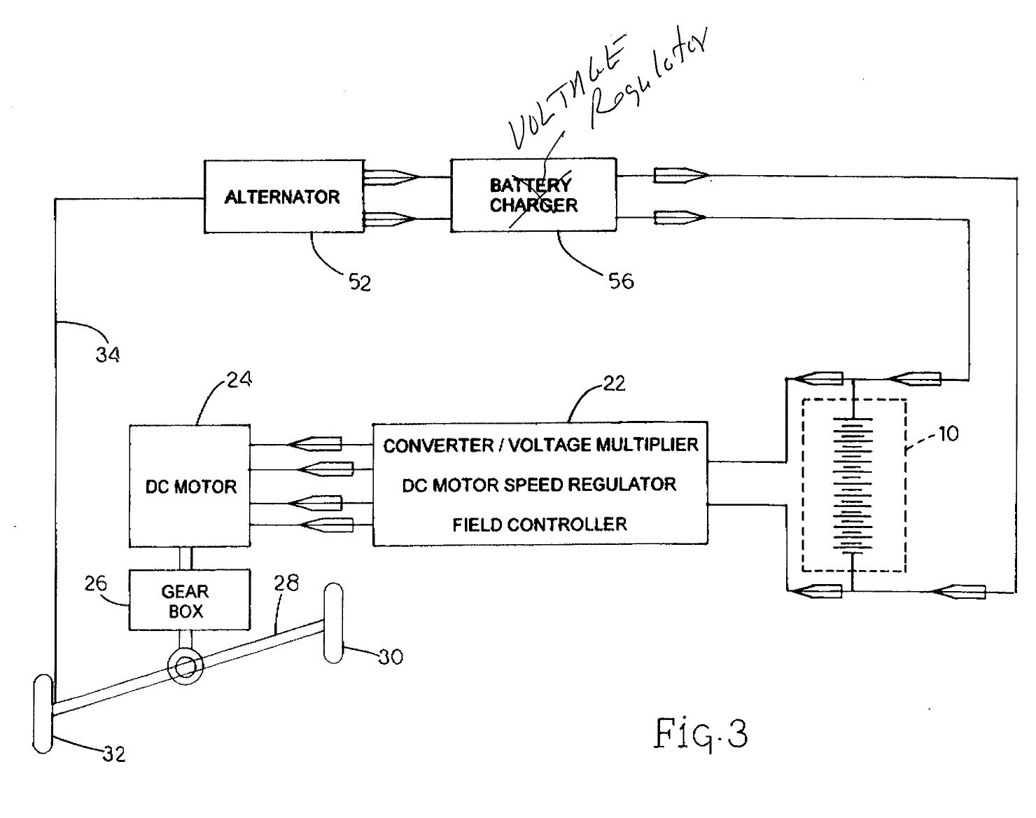

FIG. 3 is a third embodiment of the energy conversion system of the present invention.

### DETAILED DESCRIPTION OF THE INVENTION

With further reference to the drawing, particularly FIG. 1, the energy conversion system of the present invention is shown therein. The energy conversion system or power system comprises a series of components that are designed to convert the energy associated with an energy source or battery into mechanical work.

Viewing the schematic shown in FIG. 1, it is seen that the energy conversion system includes a bank of batteries 10 that are connected in series. In the embodiment illustrated herein, the bank of batteries may include a plurality of batteries connected in series that yield a voltage potential across the battery pack.

The output of the battery pack 10 is directed through lines 12 and 14 to a switch 16. A pair of lines 18 and 20 lead from switch 18 to a converter or voltage multiplier 22 that also acts as a DC speed regulator and field controller. For example, assume for purposes of illustration that the battery power source 10 includes a series of batteries that yieldS a voltage of 156 volts dc. Then, in the way of an example, the voltage multiplier of 22 is operative to increase the 156 volts DC to a selected potential, such as, for example, 312 volts DC. Accordingly, the converter or voltage multiplier 22 serves as a DC speed regulator as well as a field controller. As seen in FIG. 1, the converter or voltage multiplier 22 has an output that is directed to a DC motor 24. In the embodiment illustrated in FIG. 1, it is contemplated that the voltage supplied to the DC motor 24 could be a multiple of the voltage appearing across the battery pack 10. Again, in the way of example, the converter or voltage multiplier 22 would be operative to multiply a DC voltage input from the battery 10 to a selected voltage output that would be directed to the DC motor of 24. This output voltage would in turn drive the DC motor 24.

The DC motor 24 has an output that is directed to a conventional mechanical gear box 26. The torque delivered to the gear box 26 by the DC motor 24 is converted to an output and the output is directed to a workpiece.

In the present case and in the embodiment illustrated in FIG. 1, the workpiece comprises a wheel and axle assembly. The axle is schematically illustrated in FIG. 1 and indicated by the numeral 28. Secured to opposite ends of the axle is a pair of rotating wheels 30 and 32. Thus, it is appreciated that as the DC motor 24 is driven, that the same drives the gear box 26 and the wheels 30 and 32 are driven via the axle 28.

As illustrated in FIG. 1, wheel 30 is operatively connected to an alternator 52 through a mechanical link that is schematically illustrated and denoted by the numeral 50. That is, as the wheel 30 is rotated by the axle 28, the torque thereof is transferred by mechanical means to the alternator 52. The mechanical linkage 50 can assume various known forms. For example, the transfer of torque from the wheel 30 to the alternator 52 can be provided through a series of shafts and gears.

Alternator 52 is in turn operatively connected to a voltage regulator 56. The output of alternator 52 is utilized to provide electrical energy for energizing the voltage regulator 56. The voltage regulator 56 is in turn coupled to a switch 58 that is in turn connected to the battery pack 10. The alternator 52 and the other alternators disclosed herein will have a tendency to produce a variable output voltage. The function of the voltage regulator 56 and the other voltage regulators disclosed herein is to receive the voltage output of the alternators and to produce a generally constant or regulated voltage. As discussed above, the battery 10 can assume the form of a bank of batteries or could simply be a single battery.

Turning to wheel 32, it is operative to drive a second alternator 36 through a mechanical drive or linkage 34. The mechanical drive or linkage 34 is shown only in schematic form but it will be appreciated by those skilled in the art that various forms of mechanical linkages and/or drives can be utilized. For example, as in the case with the mechanical link 50, the linkage 34 may comprise a series of shafts interconnected by a series of gears. In fact, the gearing can be arranged such that the output of the mechanical linkage or mechanical drive 34 can be stepped up or stepped down.

In any event, the alternator 36 is operatively connected to a voltage regulator 38. The voltage regulator 38 is in turn connected to switch 40. Switch 40 is connected to lines 18 and 20 via lines 42 and 44.

Turning to FIG. 2, there is shown therein an alternate embodiment for the energy conversion system of the present invention. The system shown in FIG. 2 is much like that shown in FIG. 1 and described above. However, there are a number of specific differences.

Viewing the power system or energy conversion system shown in FIG. 2, it is seen that the same includes a bank of batteries 10 that are similar to the bank of batteries 10 illustrated in FIG. 1. The output of the bank of batteries 10 is directed through lines 60 and 64 to the converter or voltage multiplier 22. However, in line 60, there is provided a switch 62 that is effective to cut the power source or battery pack 10 off and on.

As with FIG. 1, the converter or voltage multiplier 22 of the embodiment shown in FIG. 2 functions as a DC speed regulator for a motor and as a field controller. As illustrated in FIG. 1, the output of the converter or voltage multiplier 22 is directed to a DC motor 24 that in turn drives a gear box 26. The gear box 26 drives an axle 28 that in turn drives wheels 30 and 32.

Continuing to refer to the power train or power system of FIG. 2, the torque associated with wheel 32 is transferred to an alternator 36. As discussed above, the mechanical link or linkage 34 can take on various forms such as a gear and shaft assembly. Alternator 36 is in turn operatively connected to a voltage regulator 38 which is electrically coupled to the battery pack 72. The battery pack 72 is in turn electrically coupled to the converter or voltage multiplier 22. In particular, the battery pack 72 includes output line 74 and 80. These two lines effectively connect to lines 64 and 66 which are in turn connected to the converter or voltage multiplier 22.

Wheel 30 is operatively connected to alternator 52 through the mechanical linkage 50. That is, the torque associated with the wheel 30 is transferred to the alternator 52 where the torque drives the alternator 52. Alternator 52 produces an electrical output that is utilized to energize the voltage regulator 56. Voltage regulator 56 is in turn electrically connected to a second bank of batteries 10. The second bank of batteries 10 is connected in parallel with the first bank of batteries 72. As seen in FIG. 2, the second bank of batteries 72 is connected to two output lines 74 and 80. Connected in line 74 is a second switch 76 that functions to control the output current from the second bank of batteries 72.

In the case of both FIGS. 1 and 2, the power system or energy conversion system shown therein is designed to utilize the various batteries as a power source for driving the DC motor 24 which in turn drives the workpiece or the wheel 30 and 32. In both cases, some of the energy associated with the workpiece is attempted to be recaptured and directed back to the system where the recaptured energy is utilized to charge one or more batteries and to consequently store energy that will subsequently be used. In the case of both embodiments, that is the embodiment shown in FIGS. 1 and 2, it is contemplated that one or more of the battery banks can be periodically recharged, or in the alternative, external energy can continuously or periodically be added.

In both cases, it is contemplated that the workpiece or the wheels 30 and 32 will be utilized to perform additional work. However, the focus of the invention is to recapture some of the energy associated with the workpiece, or in particularly wheels 30 and 32. In the case of FIG. 1, the recaptured energy associated with wheel 32 is simply directed through the alternator 36 and the voltage regulator 38 back to the input of the converter or voltage multiplier of 22. On the other hand, the recaptured energy associated with wheel 30 is directed to the alternator 52 which in turn energizes the voltage regulator 56 and directs the energy from the voltage regulator to the bank of batteries 10 for recharging the same and essentially storing additional energy in the bank of batteries.

In the case of the power system shown in FIG. 2, the recaptured energy associated with wheel 30 is directed to the alternator 52 which in turn produces an electrical output that is directed to the voltage regulator 56. This time the output of the voltage regulator 56 is utilized to recharge or store energy in the second bank of batteries 10. As appreciated, the second bank of batteries 10 can function to drive and power the converter or voltage multiplier 22.

Continuing to refer to the power system of FIG. 2, the recaptured energy associated with wheel 32 is utilized to drive or power the alternator 36 which in turn is connected to the voltage regulator 38. The output of the voltage regulator 38 is directed to the first bank of batteries, that is battery bank 72. Thus, it is appreciated that recaptured energy associated with wheels 30 and 32 is utilized to recharge or store recaptured energy in the battery banks 10 and 72.

Finally, turning to FIG. 3, third embodiment for the power system or energy conversion system of the present invention is shown therein. The system disclosed in FIG. 3 corresponds basically to the systems illustrated in FIGS. 1 and 2.

With reference to FIG. 3 particularly, one or more batteries 10 are connected with a converter or voltage multiplier 22 which is in turn operatively connected to a DC motor 24. The output of the DC motor is connected to a gear box 26 which is operatively coupled to a wheel and axle assembly. More particularly gear box 26 is connected to axle 28 that includes two wheels, 30 and 32 connected thereto. Interconnected between wheel 32 and alternator 52 is a mechanical linkage 34. Specifically the torque associated with wheel 32 is transferred by a mechanical linkage to the alternator 52. The alternator is in turn coupled to a voltage regulator 56 which itself is connected to the bank of batteries 10.

As discussed above, the energy conversion system shown in FIG. 3 is designed so as to recapture some of the energy associated with the wheel 32. This recaptured energy is directed to the alternator 52 which in turn energizes the voltage regulator 56. The voltage regulator then produces an output that serves to recharge the bank of batteries 10.

It should be appreciated that the batteries 10 would be periodically recharged or in the alternative and external source of energy would be provided for the energy conversion system illustrated in FIG. 3.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. An energy conversion system comprising:
a. a bank of batteries connected together in series;
b. a DC voltage multiplier operatively connected to the bank of batteries for multiplying the voltage output from the bank of batteries;
c. a DC motor operatively connected to the DC voltage multiplier wherein the DC voltage multiplier supplies a voltage to the DC motor for driving the same;
d. a gear box operatively connected to the DC motor wherein the DC motor drives the gear box;
e. a workpiece operatively connected to and driven by the gear box;
f. a voltage regulator operatively connected to the bank of batteries for charging the bank of batteries; and
g. an alternator operatively interconnected between the workpiece and the voltage regulator and wherein the alternator is coupled to the workpiece such that the workpiece drives the alternator and the alternator produces an output current that energizes the voltage regulator.

2. The energy convergent system of claim 1 wherein the workpiece includes a wheel and axle assembly that is driven by said gear box and wherein the wheel and axle assembly is operative to drive the alternator which in turn energizes the voltage regulator.

3. The energy convergent system of claim 1 wherein the DC voltage multiplier is operative to control the speed of the DC motor.

4. The energy convergent system of claim 3 wherein the bank of batteries include a series of batteries that when connected together yield a voltage of approximately 150-200 volts.

5. A method of converting energy and driving a workpiece comprising:
a. connecting a bank of batteries together in series;
b. directing an output voltage from the bank of batteries to a DC voltage multiplier;
c. directing the output of the DC voltage multiplier to a DC motor and controlling the speed of the DC motor through the DC voltage multiplier;
d. directing the output of the DC motor to a gear box;
e. directing the output of the gear box to a workpiece and driving the workpiece;
f. utilizing the workpiece to drive an alternator;
g. directing the output of the alternator to a voltage regulator; and
h. directing the output of the voltage regulator back to the bank of batteries.

6. The method of claim 5 wherein the workpiece comprising a wheel and axle assembly and wherein the wheel and axle assembly includes an axle whose torque is utilized to drive the alternator.

7. The energy conversion system of claim 1 further including a second alternator operatively connected to the workpiece and wherein the workpiece is operative to drive the second alternator; a voltage regulator operatively interconnected between the second alternator and the voltage multiplier for directing an electrical output therefrom to the voltage multiplier.

8. The energy conversion system of claim 1 wherein there is provided a switch between the bank of batteries and the voltage multiplier.

9. The energy conversion system of claim 1 including an external battery for providing power to the energy conversion system independently of the power provided by the bank of batteries.

10. The energy conversion system of claim 1 wherein there is provided a second bank of batteries connected in parallel with the first bank of batteries and wherein the first and second bank of batteries are operative to provide power to the voltage multiplier either together or independently of each other.

11. A power system, comprising: at least one battery; a DC motor operatively driven by the battery; a workpiece driven by the DC motor; and an energy recapture system for recapturing energy from the workpiece in response to the workpiece being driven by the DC motor and wherein the energy recapture system is operative to transfer the recaptured energy to the battery where the recaptured energy is stored in the battery.

12. The power system of claim 11 further including a DC motor speed regulator operatively interconnected between the battery and the DC motor for regulating the speed of the DC motor.

13. The power system of claim 12 wherein the energy recapture system includes an alternator and a voltage regulator and a mechanical connection disposed between the workpiece and the alternator for transferring energy from the workpiece to the alternator, and wherein the alternator functions to provide an output that drives the voltage regulator which is in turn connected to the battery.

14. The power system of claim 13 wherein there is provided a switch between the battery and the DC motor speed regulator and a second switch between the battery and the voltage regulator.

15. The power system of claim 14 further including a second alternator and a voltage regulator connected between the workpiece and the motor speed regulator.
